(19) United States
(12) Patent Application Publication
(10) Pub. No.: US 2005/0194050 A1
(43) Pub. Date: Sep. 8, 2005

(54) Breathing gas dispenser with selectable output flow rates

(76) Inventor: Dennis P. Pietrantoni, Lancaster, NY (US)

Correspondence Address: HODGSON RUSS LLP, ONE M & T PLAZA, SUITE 2000, BUFFALO, NY, 14203-2391, US

(21) Appl. No.: 11/072,156

(22) Filed: Mar. 4, 2005

Related U.S. Application Data
(60) Provisional application No. 60/550,247, filed on Mar. 4, 2004.
(60) Provisional application No. 60/564,511, filed on Apr. 22, 2004.

(51) Int. Cl. A62B 9/02

(52) U.S. Cl. 137/613

(57) ABSTRACT

A breathing gas dispenser with selectable output flow rates. The dispenser includes a vessel containing a supply of breathable gas at storage pressure. The vessel is in fluid communication with a regulator assembly capable of reducing the pressure of the gas to a delivery pressure in a chamber. A plate is disposed in the chamber. The plate has a plurality of openings defined therein. The openings are disposed in pairs including a first opening and a second opening. The first or second opening or both may contain an orifice housing with a precision metering orifice defined therein. A flow selector is capable of causing the plate to rotate such that each of the pairs of openings are sequentially brought into registry with the outlet such that a user can select an output flow rate.

### CROSS-REFERENCE TO RELATED APPLICATIONS

This application claims the benefit of U.S. Provisional Patent Application Nos. 60/550,247 filed Mar. 4, 2004, and 60/564,511 filed Apr. 22, 2004.

### FIELD OF THE INVENTION

The present invention relates to a breathing gas system or a “walk around bottle” system, for use in aircraft.

### BACKGROUND OF THE INVENTION

The use of breathing gas systems on aircraft is known. It has been known to provide breathing gas systems with fixed output flow rates. Many of the systems are supplied with multiple outlets, each outlet being preset to deliver a different flow rate.

There is a need for a breathing gas dispenser with selectable output flow rates that relies on flow control by calibrated orifice.

### SUMMARY OF THE INVENTION

The present invention meets the above-described need by providing a breathing gas dispenser with selectable output flow rates. The dispenser includes a vessel containing a supply of breathable gas at storage pressure. The vessel is in fluid communication with a regulator assembly. The regulator assembly is capable of reducing the pressure of the gas to a delivery pressure in a chamber. The chamber has an outlet. A plate is disposed in the chamber. The plate has a plurality of openings defined therein. The openings are disposed in pairs comprising a first opening and a second opening. The first or second opening or both may contain an orifice housing with a precision metering orifice defined therein. A flow selector is capable of causing the plate to rotate such that each of the pairs of openings are sequentially brought into registry with the outlet such that a user can select an output flow rate.

### BRIEF DESCRIPTION OF THE DRAWINGS

The invention is illustrated in the drawings in which like reference characters designate the same or similar parts throughout the figures of which:

FIG. 1 is a block diagram of the present invention;

FIG. 2 is a front elevational view of the selectable flow regulator assembly of the present invention with the cover removed for clarity;

FIG. 3 is a side elevational view of the selectable flow regulator assembly of the present invention with the cover removed for clarity;

FIG. 4 is a cross-sectional view taken along lines 4-4 of FIG. 3;

FIG. 5 is a cross-sectional view taken along lines 5-5 of FIG. 4;

FIG. 6 is an elevational view of the indexer of the present invention;

FIG. 7 is a top plan view of the indexer with the orifice plate installed therein;

FIG. 8 is a cross-sectional view taken along lines 8-8 of FIG. 7;

FIG. 9 is a top perspective view showing the low pressure chamber;

FIG. 10 is a top plan view of the selectable flow regulator assembly; and,

FIG. 11 is a cross-sectional view taken along lines 11-11 of FIG. 10;

FIG. 12 is a block diagram of an alternate embodiment of the present invention;

FIG. 13 is a cross-sectional view of the flow selector of the breathing gas dispenser of FIG. 12; and,

FIG. 14 is an exploded view of the flow selector of the breathing gas dispenser of FIG. 12.

### DETAILED DESCRIPTION

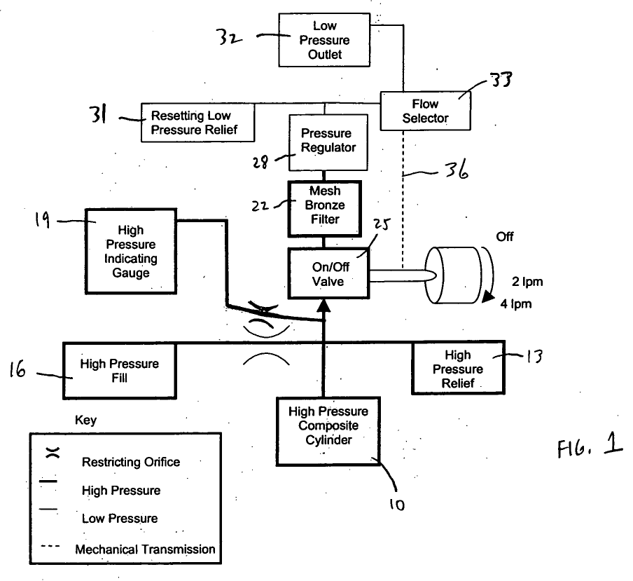

Referring to FIG. 1, a breathing gas supply system provides supplemental breathing gas for persons that may require supplemental breathing gas for medical or therapeutic use or for use at higher altitudes. The breathing gas supply system may be made lightweight and small enough to be carried on the person of the user and therefore may be easily transported by an adult in a crowded environment.

The pressure vessel 10 may be manufactured of a composite material such as an aluminum liner with a carbon fiber over-wrap and an epoxy resin finish as will be evident to those of ordinary skill in the art. The vessel 10 may have a nominal volume up to 140 cubic inches and may store breathing gas at pressures up to 1850 p.s.i.g. (hereinafter referred to as “storage pressure”).

As will also be evident to those of ordinary skill in the art based on this disclosure, the pressure vessel 10 is typically provided with a high pressure relief valve 13, a high pressure fill valve 16, an indicating gauge 19 and a filter 22. The high pressure relief valve 13 may be of a frangible disc type. The high pressure fill valve 16 is a normally closed check valve. Application of a pressure higher than the storage pressure will cause the check valve to open and the storage pressure can be replenished. The indicating gauge 19 may be of a direct drive type. The filter 22 captures particles that may be generated by the mechanical interaction of the upstream components prior to reaching the regulator inlet.

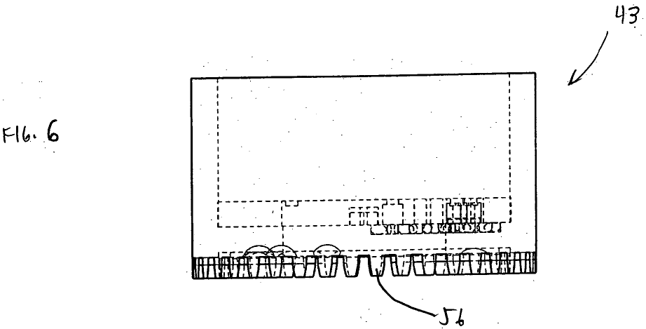

When an on-off valve 25 is opened, gas flow is allowed to pass to the inlet passage 26 (FIG. 4) of a balanced-type regulator assembly 28. Other types of fluid controlling regulators may also be suitable. The regulator assembly 28 accepts storage pressure between 150 and 1850 p.s.i.g. and reduces it to approximately 70 p.s.i.g. at the flow selector 33. A resetting low pressure relief valve 31 is connected to the regulator. The low pressure relief valve 31 opens between 90 and 135 p.s.i.g. to vent pressure in the event of a regulator malfunction such as leakage past the regulating seat of regulator assembly 28 in a no flow condition or other condition causing excess pressure. This valve 31 protects low pressure components from being over pressurized. The low pressure relief valve 31 will reset automatically when the regulated pressure returns to normal levels.

A flow selector 33 provides for switching between precise metering rates and is coupled to the control knob 50 for the on/off valve 25 as indicated by dashed lines 36.

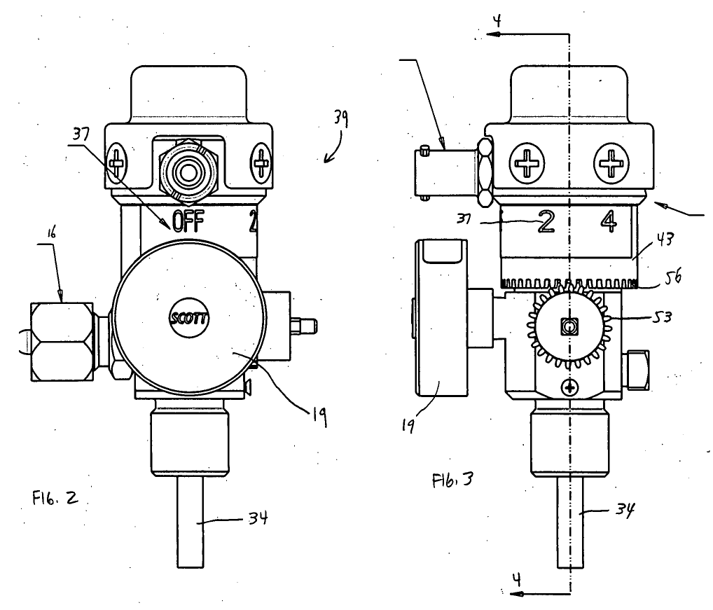

Turning to FIG. 2, the indicating gauge 19 is disposed on the front of the selectable flow regulator assembly 39. The fill valve 16 is shown at the left of the figure. A drain tube 34 is provided to prevent water condensation from inside the cylinder from entering the valve. A visual indicator 37 of the status of the selectable flow assembly 39 is also provided.

A control knob 50 (FIG. 4) allows the user to manually open the on/off valve 25 and select the desired flow setting. The knob 50 synchronizes the position of the on/off valve 25 with an indexer 43 as will be described in greater detail below. The on/off valve 25 may be made of VESPEL® material which is commercially available (VESPEL® is a registered trademark of E.I. duPont Nemours and Company), and the high pressure seal is made by impressing the VESPEL® valve onto a brass seat 44 (FIG. 4). Other materials may also be suitable.

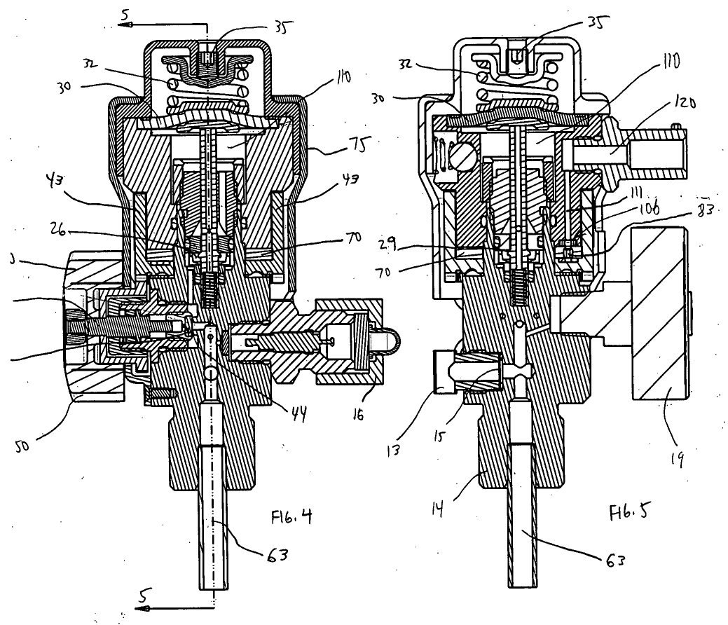

In FIG. 3, the cover and knob 50 (best shown in FIGS. 4, 10 and 11) have been removed to show a face gear 53 at the base of the on/off knob 50 that mates with a pinion 56 on the bottom of the indexer 43. The indexer 43 is a cylindrical housing that retains the orifice plate 70 (FIG. 4). Although the knob 50 is coupled to the indexer 43 by a face gear and pinion arrangement it will be evident to those of ordinary skill in the art that other arrangements for coupling the knob 50 to the indexer 43 may also be suitable.

Turning to FIGS. 4-5, a central passage 63 communicates storage pressure to the high pressure relief valve 13, fill valve 16, storage pressure gauge 19 and on/off valve 25. Passage 63 is formed in high pressure valve body 14. Relief valve 13 includes a rupture disc 15. The first three-quarters of a turn of knob 50 opens the on/off valve 25 by means of a shaft 60 that rotates a threaded member carrying the VESPEL® valve off of its brass seat 44. Upon opening the on/off valve 25 by rotating the knob 50, storage pressure is applied to a balanced-type pressure regulator 28 which reduces it to a lower pressure. The regulator 28 has a stem 29. Regulator 28 may also include a diaphragm 30, a regulator opening spring 32, and an adjusting screw 35 as will be evident to those of ordinary skill in the art. The regulated pressure travels through inlet passage 26 into low pressure chamber 110. As described in greater detail below, this lower regulated pressure is applied to the interface between the low pressure body 69 and the indexer 43.

Turning of the knob 50 opens the on/off valve 25 through rotation of shaft 60. As described above, the knob 50 is also coupled to the indexer 43 by means of the engagement of the face gears 53 attached to the knob 50 with pinion 56 attached to or formed integrally with the indexer 43. Accordingly, turning of the knob 50 also causes an orifice plate 70 retained by the indexer 43 to rotate. Rotation of the orifice plate 70 causes the flow setting to switch. When the indexer 43 rotates, it repositions the orifice plate 70 to allow multiple flow rates. The visual indicator 37 located on the outside surface of the indexer 43 indicates the flow setting (i.e., in the example shown, there are three positions: off, “2” or “4” liters per minute). The visual indicator 37 aligns with a window (not shown) in the protective cover 75.

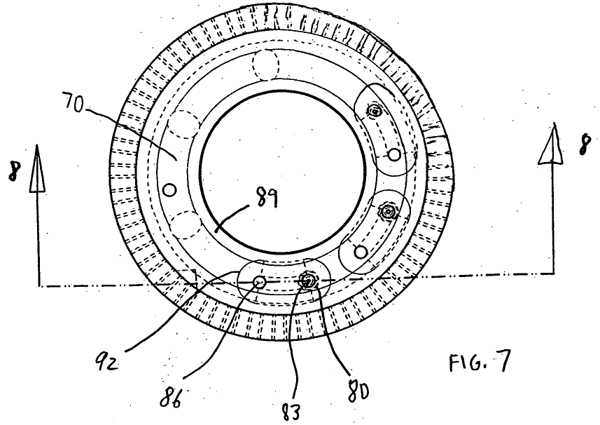

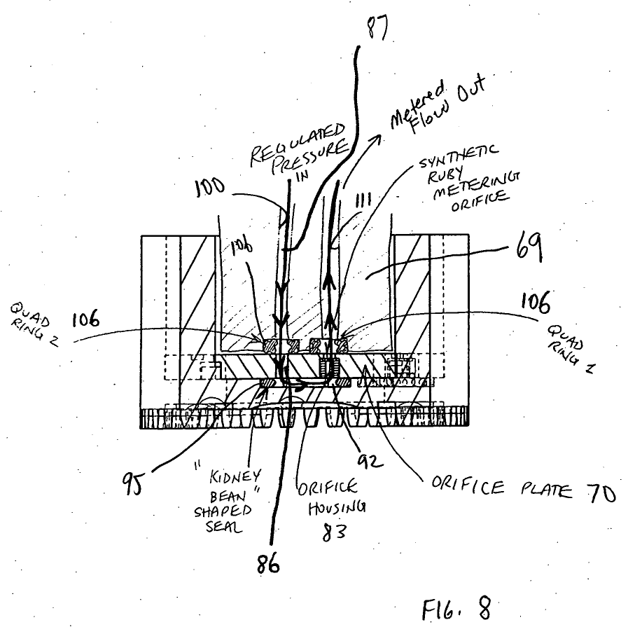

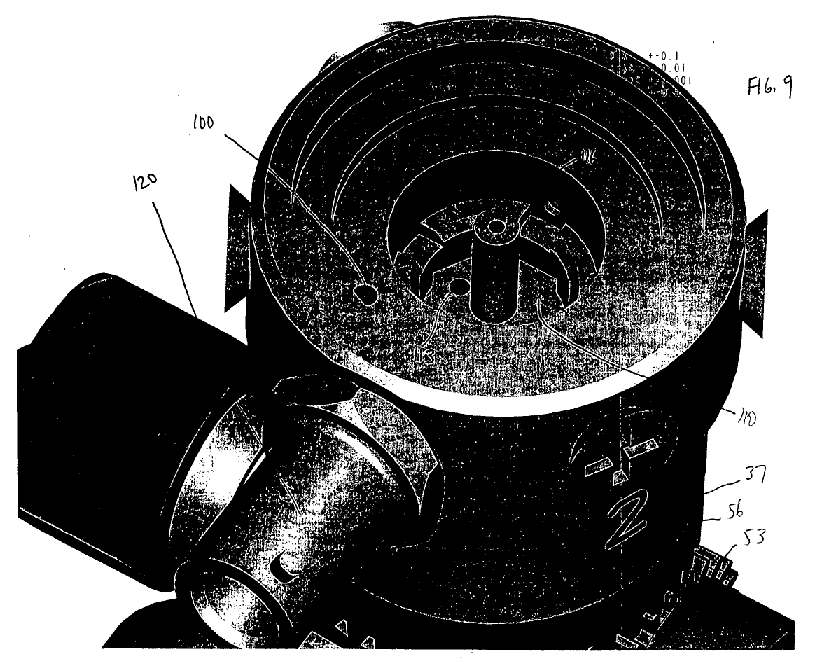

In FIGS. 6-8, the indexer 43 and orifice plate 70 are shown in greater detail. The assembly includes the indexer 43, the orifice plate 70, and a number of seals. The orifice plate 70 may be constructed of suitable materials and may be approximately 0.1″ thick. An orifice housing 80 containing a precisely drilled orifice may be pressed into an opening in the orifice plate 70. The orifice 83 may be constructed of ruby or other suitable materials. The precisely calibrated orifice 83 in the orifice housing 80 meters the flow to the desired value based upon its diameter and the upstream pressure. In addition to the calibrated metering orifices, the orifice plate 70 also has holes drilled into it that pass completely through the orifice plate. These through holes 86 are on a different diameter than the pressed orifices, and are disposed in pairs with the openings for receiving the orifice housing 80. The indexer 43 has a bottom wall 89. Cavities 92 are defined within orifice plate 70. In the example shown there are three such cavities, however other numbers are also suitable. The cavities 92 on the orifice plate 70 are formed in registry with the through holes 86 and calibrated orifices 83. The indexer 43 and orifice plate 70 are sealed around the cavities by seals 95 (FIG. 8).

As shown in FIG. 8, the interface between passageway 100 through the low pressure body 69 and the orifice plate 70 may be sealed by quad ring seals 106.

When the passageway 100 is pressurized with a fixed regulated pressure, flow passes along the flow path indicated by arrows 87 down the passageway 100 and into the through hole 86 in the orifice plate 70. Next, the flow enters the cavity 92 in the plate 70 and then exits the cavity 92 through the precisely calibrated orifice 83 back up through a second passageway 111 where it is communicated to the outlet 120 for the user.

The passageway 100 through the low pressure body 69 is fixed such that rotation of the indexer 43 successively brings each pair of openings in the orifice plate 70 into registry with the passageways. The quad ring seals 106 provide the necessary seals at the interface between the passageway 100 and the through hole 86 in the orifice plate and between the calibrated orifice 83 and the second passageway 111.

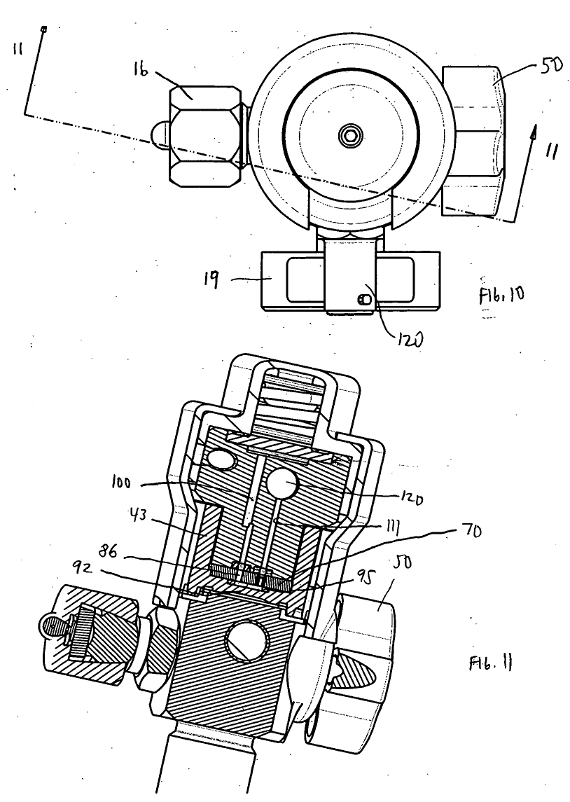

Turning to FIG. 9, the low pressure chamber 110 is located above the low pressure body 69 as shown. A first opening 113 at the bottom of the chamber 110 provides the entry point for regulated pressure that has been reduced from storage pressure by the balanced type pressure regulator 28. A passageway 116 leading to the low pressure relief valve 31 is shown in the side wall. In the alternative, the low pressure relief valve 31 may be located at other positions along the flow path as will be evident to those of ordinary skill in the art. The passageway 100 leading to the orifice plate 70 is also shown in FIG. 9. The position of the passageway 100 is fixed and the indexer 43 moves each successive pair of openings into registry with the passageways 100 and 111.

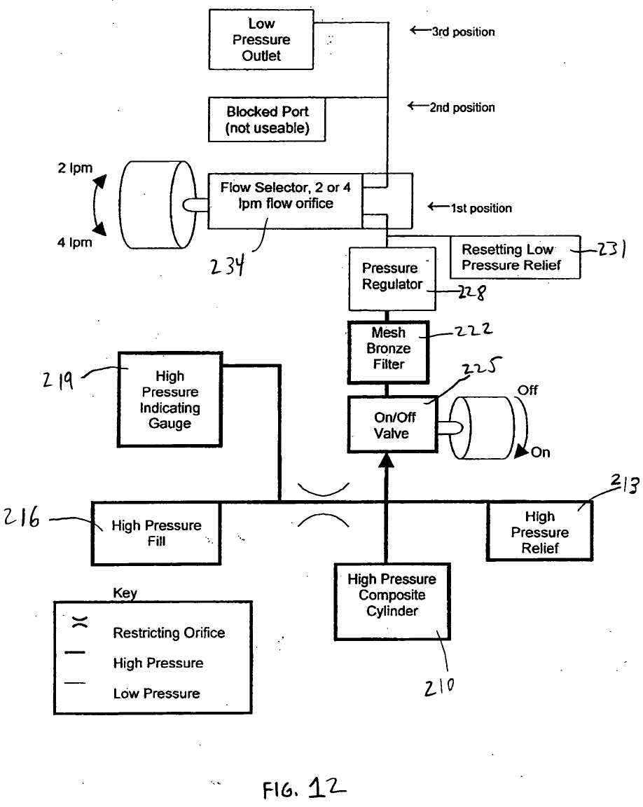

In FIGS. 10 and 11, the flow path through the low pressure body 69, orifice plate 70 and indexer 43 is shown in greater detail. As described the regulated pressure passes through passageway 100 into the through hole 86 in the orifice plate 70. The low pressure body 69 and orifice plate 70 are sealed by the quad ring seals 106. The flow passes into the cavity 92 in the plate 70 where it is sealed by kidney shaped seals 95. The flow then passes through the precisely calibrated opening 83, back through a second passageway 111 in the low pressure body and into the outlet 120 for communication with the user.

Referring to FIG. 12, an alternate embodiment of the present invention is shown in a block diagram. The pressure vessel 210 may be manufactured of a composite material such as an aluminum liner with a carbon fiber over-wrap and an epoxy resin finish as will be evident to those of ordinary skill in the art. The vessel 210 may have a nominal volume up to 140 cubic inches and may store breathing gas at pressures up to 1850 p.s.i.g. (hereinafter referred to as “storage pressure”).

As will also be evident to those of ordinary skill in the art based on this disclosure, the pressure vessel 210 is typically provided with a high pressure relief valve 213, a high pressure fill valve 216, an indicating gauge 219 and a filter 222. The high pressure relief valve 213 may be of a frangible disc type. The high pressure fill valve 216 is a normally closed check valve. Application of a pressure higher than the storage pressure will cause the check valve to open and the storage pressure can be replenished. The indicating gauge 219 may be of a direct drive type. The filter 222 captures particles that may be generated by the mechanical interaction of the upstream components prior to reaching the regulator inlet.

When an on-off valve 225 is opened, gas flow is allowed to pass to the inlet passage of a regulator 228. The regulator 228 accepts any pressure between 150 and 1850 p.s.i.g. and reduces it to approximately 55 p.s.i.g. A resetting low pressure relief valve 131 is connected to the regulator. The low pressure relief valve 231 opens between 90 and 135 p.s.i.g. to vent pressure in the event of a regulator malfunction such as leakage past the regulating seat (not shown) of regulator 228 in a no flow condition or other condition causing excess pressure. This valve 231 protects low pressure components from being over pressurized. The low pressure relief valve 231 will reset automatically when the regulated pressure returns to normal levels.

As shown in the diagram, the regulator 228 is provided with an outlet position (“Port 1”) capable of receiving a flow selector 234 of the present invention. Accordingly, Port 1 designates a fitting on the regulator 228 that is capable of receiving the flow selector 234 of the present invention. As will be described in greater detail below, the flow selector 234 receives regulated pressure from the pressure regulator 228, meters it to a user selected flow rate and allows it to pass into one or more outlets for user connected devices such as breathing masks (not shown).

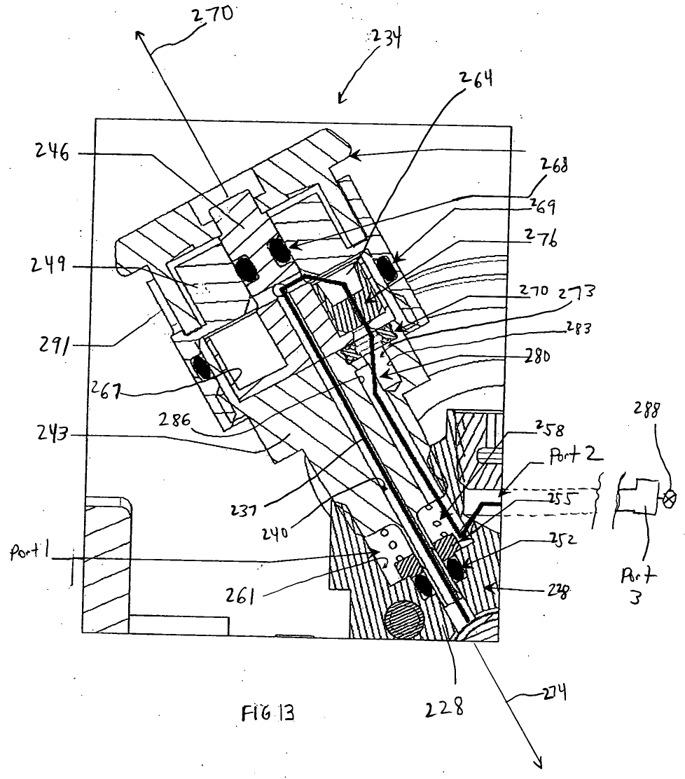

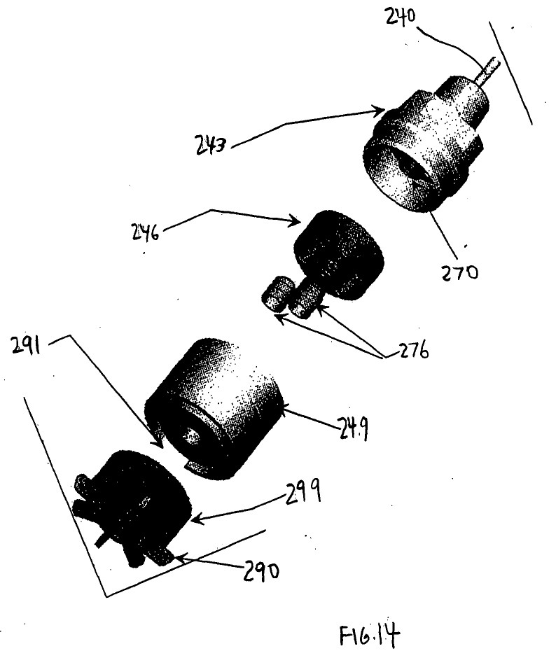

Turning to FIG. 13, the path of breathing gas flow is depicted by the heavy line 237. Pressure from the output of the regulator 228 is applied to the passageway 240 disposed through the center of the flow selector 234. The flow selector 234 includes three main components a selector body 243, a cylinder 246 and a seal nut 249, which will be described in greater detail herein. The flow selector 234 is received in a first outlet Port 1 of the regulator 228 which is specially designed to engage with the flow selector 234. An O-ring 252 seals the opening where the passageway 240 interfaces with regulator 228. The O-ring 252 is retained by a washer 255 and a spring 258, and the O-ring 252 seals the regulated pressure from escaping into a cavity 261 in Port 1.

The regulated pressure travels through the passageway 240 through the flow selector 234 until it pressurizes the cavity 264 of the selector body 243 containing the cylinder 246. The cylinder 246 has multiple chambers 267 disposed around its circumference. When the chambers 267 are rotated about an axis of rotation 270, each chamber 267 rotates sequentially into alignment with a passageway 273 defined in the selector body 243 at an offset from the longitudinal axis 274 of the selector body 243. The chambers 267 are capable of receiving calibrated orifices 276 of specific flow rate. The metering orifices 276 are precisely machined parts that are pre-calibrated such that they will provide specific flow rates at predetermined pressure differentials. Accordingly, the system of the present invention does not have to be calibrated for flow when the calibrated orifices 276 are installed or changed.

By way of example only, the embodiment shown has six chambers 267 with two chambers containing metering orifices 276 (best shown in FIG. 14). In FIG. 13, a metering orifice 276 is present in the chamber 267 on the right hand side of the figure and the chamber 267 on the left hand side of the figure is empty.

The seal nut 249 attaches the cylinder 246 to the selector body 243. O-ring 268 between the cylinder 246 and the seal nut 249 and O-ring 269 between the seal nut 249 and the selector body 243 prevent the regulated pressure from escaping to atmosphere.

A quad ring 270 seals the interface between the metered orifice 276 and passageway 273 inside the selector body 243 to prevent the regulated pressure from leaking into the passageway 280 formed by intersecting drills 283 and 286 in selector body 243.

The pressure above or upstream of the metering orifice 276 is the regulated pressure, and the pressure below or downstream of the orifice 276 is communicated to the cavity 261 inside Port 1. When Port 1 of the regulator 228 is configured with the flow selector 234 of the present invention, the output of the flow selector is directed to Port 2 as shown in FIG. 13. There may be other ports provided and interconnected with Port 2.

Port 3 may be connected to breathing masks (not shown) or other devices. Port 3 may be provided with a check valve 288. When the check valve 288 of the outlet in Port 3 is opened, all the ports are exposed to ambient pressure. Therefore, the pressure below the metering orifice 276 is atmospheric pressure. The pressure differential above and below the metering orifice 276 will cause the gas to flow through the orifice 276. The metering orifice 276 is sized so that the differential pressure provides a specific user requested flow rate. The gas flow follows the path 237 indicated by the heavy line 237 into cavity 261 in Port 1, to Port 2, and out to the user through Port 3.

Turning to FIG. 14, the cylinder 246 has multiple chambers 267 formed within it. Each chamber 267 is capable of receiving a calibrated orifice 276 of specific flow rate. Since the flow path allowing gas to pass to the user is offset from the center of the selector body 243, only one of the orifices 276 can be aligned to allow gas to flow to the user. The cylinder 246 and knob 290 are fixedly attached such that as the knob 290 is rotated the cylinder 246 rotates with it. The knob 290 may be rotated in either direction or it may be ratcheted to rotate in a single direction as will be evident to those of ordinary skill in the art.

The user rotates the knob 290 to align different orifices 276 within the cylinder 246 with the flow path to the user. Accordingly, the user can select from multiple different flow rates (up to six different flow rates in this example). One of the positions in cylinder 246 may be configured to provide a no-flow position by means of a closed chamber 267 (as shown on the left side of FIG. 13) or by plugging one of the orifices 276.

The specific flow rates associated with the orifices 276 loaded into the cylinder 246 may be printed on the cylindrical surface 299 of the knob 290. The flow rate of the orifice 276 that is aligned to flow gas to the user can be seen on the surface of knob 290 through a window 291 on the seal nut 249. This indicator notifies the user of and allows him to select the desired flow rate. The knob 290 and cylinder 246 may be detented in various ways as will be evident to those of ordinary skill in the art to provide an indication when a specific orifice is aligned for a specific flow rate. For example, a spring (i.e., ball and spring arrangement) may be used to provide a torque threshold that must be exceeded in order to rotate the cylinder 146 to another orifice 276. Also, a positive locking mechanism with a release button could also be used.

The flow selector 234 of the present invention may be disposed in fluid communication with a single outlet leading to a breathing mask as described above. The flow selector 234 of the present invention may also be disposed in fluid communication with more than one outlet connected in parallel. As a result the flow selector 234 of the present invention can be used to simultaneously feed multiple outlets. If the outlets are connected to masks or other devices having similar resistance, then the gas flow will divide substantially equally between the outlets.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention. Also, the shapes of some of the components may vary due to weight reduction considerations. For instance, depending on the number of different calibrated orifices required, the indexer and orifice plate could be oval-shaped, or clover-shaped or the like.

1. A breathing gas dispenser with selectable output flow rates, the dispenser comprising:
a vessel containing a supply of breathable gas at storage pressure, the vessel in fluid communication with a regulator assembly, the regulator assembly capable of reducing the pressure of the gas to a delivery pressure in a chamber, the chamber having an outlet;
a plate disposed in the chamber, the plate having a plurality of openings defined therein, the openings disposed in pairs comprising a first opening and a second opening, at least one of the first and the second opening containing an orifice housing with a precision metering orifice defined therein; and,
a flow selector capable of causing the plate to rotate such that each of the pairs of openings are sequentially brought into registry with the outlet such that a user can select an output flow rate.

2. The breathing gas dispenser of claim 1, wherein the flow selector comprises an indexer having the plate mounted therein.

3. The breathing gas dispenser of claim 2, wherein the indexer is coupled to a knob having a positive locking mechanism.

4. The breathing gas dispenser of claim 3, wherein the indexer is coupled to a knob having a detent mechanism.

5. The breathing gas dispenser of claim 4, wherein the detent mechanism comprises a ball and spring.

6. The breathing gas dispenser of claim 2, further comprising a knob coupled to the indexer and coupled to an on/off valve such that the knob can be used to control the on/off valve and the output flow rate.

7. The breathing gas dispenser of claim 6, wherein one of the indexer and knob comprise a gear and one of the indexer and knob comprise a pinion such that motion of the flow selector causes the indexer to rotate thereby causing the plate to rotate.

8. The breathing gas dispenser of claim 1, wherein a gas inlet is disposed through a central opening in the plate.

9. The breathing gas dispenser of claim 1, wherein the orifice housing is press fit into the plate.

10. The breathing gas dispenser of claim 1, wherein the orifice housing comprises ruby.

11. The breathing gas dispenser of claim 1, further comprising a valve body having a first passageway in fluid communication with the regulator assembly and in fluid communication with the first opening in the plate, the valve body having a second passageway in fluid communication with the precision metered orifice and the outlet.

12. The breathing gas dispenser of claim 11, further comprising a chamber disposed between the plate and a bottom wall of the indexer such that gas flowing from the first passageway through the first opening in the plate enters the chamber and exits the chamber through the precision metering orifice to the outlet through the second passageway.

13. The breathing gas dispenser of claim 1, wherein the gas dispenser is capable of being carried on the person of the user.

14. A breathing gas dispenser with selectable output flow rates, the dispenser comprising:
a vessel containing a supply of breathable gas at storage pressure, the vessel being in fluid communication with a regulator assembly, the regulator assembly reducing the pressure of the gas to a delivery pressure in a chamber, the chamber having an outlet;
a valve member disposed in fluid communication with the chamber, the valve member having a first passageway and a second passageway;
an indexer having an opening for receiving the valve member and having a bottom wall, the indexer capable of rotating relative to the valve member;
a plate mounted in the indexer, the plate having a plurality of openings defined therein, the openings disposed in pairs comprising a first opening and a second opening, at least one of the first and the second opening containing an orifice housing having a precision metering orifice disposed therein;
a chamber disposed between the plate and the bottom wall of the indexer; and,
a knob capable of causing the indexer to rotate such that each pair of openings in the plate is sequentially brought into registry with the first and second passageways in the valve member.

15. The breathing gas dispenser of claim 14, wherein one of the indexer and knob comprise a gear and one of the indexer and knob comprise a pinion such that motion of the flow selector causes the indexer to rotate thereby causing the plate to rotate.

16. The breathing gas dispenser of claim 14, further comprising a gas inlet disposed through a central opening in the plate.

17. The breathing gas dispenser of claim 14, wherein the orifice housing is press fit into the plate.

18. The breathing gas dispenser of claim 14, wherein the orifice housing comprises ruby.

19. The breathing gas dispenser of claim 14, wherein the gas dispenser is capable of being carried on the person of the user.

20. A breathing gas dispenser with selectable output flow rates, the dispenser comprising:
a vessel containing a supply of a breathable gas at storage pressure, the vessel in fluid communication with a regulator assembly, the regulator assembly reducing the pressure of the gas to a delivery pressure in a chamber, the chamber having an outlet;
a valve member having a passageway defined therein, the valve member having a central portion and a plurality of compartments disposed around the periphery of the central portion;
at least one removable insert having a precision metering orifice, the insert capable of being received in one of the compartments in the valve member; and,
a knob coupled to the valve member such that rotation of the knob causes the valve member to rotate such that the precision metering orifice in the at least one insert is disposed in registry with the outlet.

21. The breathing gas dispenser of claim 20, wherein the central portion of the valve member is cylindrical.

22. The breathing gas dispenser of claim 20, wherein the knob is attached to the valve member.

23. The breathing gas dispenser of claim 20, further comprising a seal nut attaching the valve member to a selector body, the selector body having a first passageway disposed in fluid communication with the vessel and the passageway in the valve member.

24. The breathing gas dispenser of claim 20, wherein the valve member comprises a cylindrical portion extending to a bottom wall, the bottom wall extending substantially perpendicular to the cylindrical portion, the bottom wall extending to an upstanding wall disposed in spaced apart relation to the cylindrical portion such that a compartment is formed.

25. The breathing gas dispenser of claim 20, wherein the removable insert is U-shaped in cross-section.

26. The breathing gas dispenser of claim 25, wherein the selector body has a second passageway in fluid communication with the outlet.

27. The breathing gas dispenser of claim 20, wherein the passageway in the valve member is collinear with an axis of rotation of the valve member.

28. The breathing gas dispenser of claim 20, wherein the valve member has a closed compartment such that a no flow position occurs when the closed compartment is brought into registry with the outlet.

29. The breathing gas dispenser of claim 20, wherein the knob has a positive locking mechanism.

30. The breathing gas dispenser of claim 20, wherein the knob has a detent mechanism.

31. The breathing gas dispenser of claim 30, wherein the detent mechanism comprises a ball and spring.
